(19) United States
(12) Patent Application Publication
(10) Pub. No.: US 2003/0018769 A1
(43) Pub. Date: Jan. 23, 2003

(54) Method of backtracing network performance

(76) Inventors: Davis Foulger, Wappingers Fall, NY (US); William Minckler, Waltham, MA (US); Robert E. McElhaney, Berwick, ME (US); John Esposito, Marlborough, MA (US); William Babcock, Lakeville, MA (US)

Correspondence Address: DALY, CROWLEY & MOFFORD, LLP, SUITE 101, 275 TURNPIKE STREET, CANTON, MA, 02021-2310, US

(21) Appl. No.: 09/911,216

(22) Filed: Jul. 23, 2001

Related U.S. Application Data
(60) Provisional application No. 60/220,918, filed on Jul. 26, 2000.

(51) Int. Cl. G06F 15/173

(52) U.S. Cl. 709/223

(57) ABSTRACT

The present invention provides a method of backtracing network performance by locating a Quality of Service (QOS) monitor at a web site that actively monitors incoming traffic. When the monitor detects a new user, the monitor traces the route back to the user, measuring the performance of as many intermediate links as the monitor can traverse. In some cases, this trace will extend back all the way to the end users machines. More often the trace will end at a corporate firewall or a router near the end users dial-up modem pool. Regardless of how close to the user the trace gets, it will track the performance of the actual routes that are being traversed by actual users at the time that those users are actually accessing the web site. The result, spread across measurements of many users, is a snapshot of the network quality of service that the site is actually experiencing, for the routes that are actually being used to access the site. Accordingly, a more realistic and accurate result is obtained.

### CROSS REFERENCE TO RELATED APPLICATIONS

This application claims priority under 35 U.S.C. § 119(e) to provisional patent application serial No. 60/220,918 filed Jul. 26, 2000; the disclosure of which is incorporated herein by reference.

### BACKGROUND OF THE INVENTION

Internet performance is inherently unpredictable. There is no such thing as a guaranteed quality of service on open Internet links. This does not prevent web sites from improving the quality of service they provide to their customers, it simply makes improved quality of service difficult to attain and maintain. Indeed, an entire industry has grown up around the business of quantifying web site quality of service such that it can be improved and another whole industry is now focusing on the business of providing the means of quality of service improvement. The business of quantifying web site performance is currently exemplified by the services of companies such as Keynote, which provides subscribing web site owners with detailed data about their sites global quality of service and comparative data that allows web sites to see how they compare with their competitors and other similar web sites.

The usual approach to web quality of service monitoring is exemplified by the products and services of Keynote, which has co-located quality of service monitors at a larger number of ISP sites and measures network performance from those ISP sites to a variety of web sites, most of them subscribers to Keynotes service offerings. This approach has an inherent limitation, which is their fixed measurement points, which monitor performance from a range of high volume intermediate points, but don't necessarily measure from the internet routes a web sites users are actually coming from, even when they are accessing the web site from the same cities that Keynote's monitors are located in. Another limitation associated wit this approach includes their fixed monitoring schedules, which measure the network at a wide variety of times, but don't necessarily measure any particular route on the network at the particular time that a sites users are traversing it.

### SUMMARY OF THE INVENTION

With the foregoing background in mind, it is an object of the present invention to locate a Quality of Service (QOS) monitor at a web site that actively monitors incoming traffic. When the monitor detects a new user, the monitor traces the route back to the user, measuring the performance of as many intermediate links as the monitor can traverse. In some cases, this trace will extend back all the way to the end users machines. More often the trace will end at a corporate firewall or a router near the end users dial-up modem pool. Regardless of how close to the user the trace gets, it will track the performance of the actual routes that are being traversed by actual users at the time that those users are actually accessing the web site. The result, spread across measurements of many users, is a snapshot of the network quality of service that the site is actually experiencing, for the routes that are actually being used to access the site. Accordingly, a more realistic and accurate result is obtained.

### BRIEF DESCRIPTION OF THE DRAWINGS

The invention will be better understood by reference to the following more detailed description and accompanying drawings in which:

FIG. 1 is a diagram of a typical web installation of the present invention;

FIG. 2 is a diagram showing the general architecture of the back-tracing system;

FIG. 3 is a summary view of network performance;

FIG. 4 is a geographical view of network performance;

FIG. 5 shows a table view of the weather context;

FIG. 6 shows a topological view of the Weather Context;

FIG. 7 shows a network over time view of network performance;

FIG. 8 shows a website volume over time view of network performance;

FIG. 9 shows a volume distribution view of network performance;

FIG. 10 shows a network latency over time view of network performance; and

FIG. 11 shows a latency distribution view of network performance.

### DETAILED DESCRIPTION

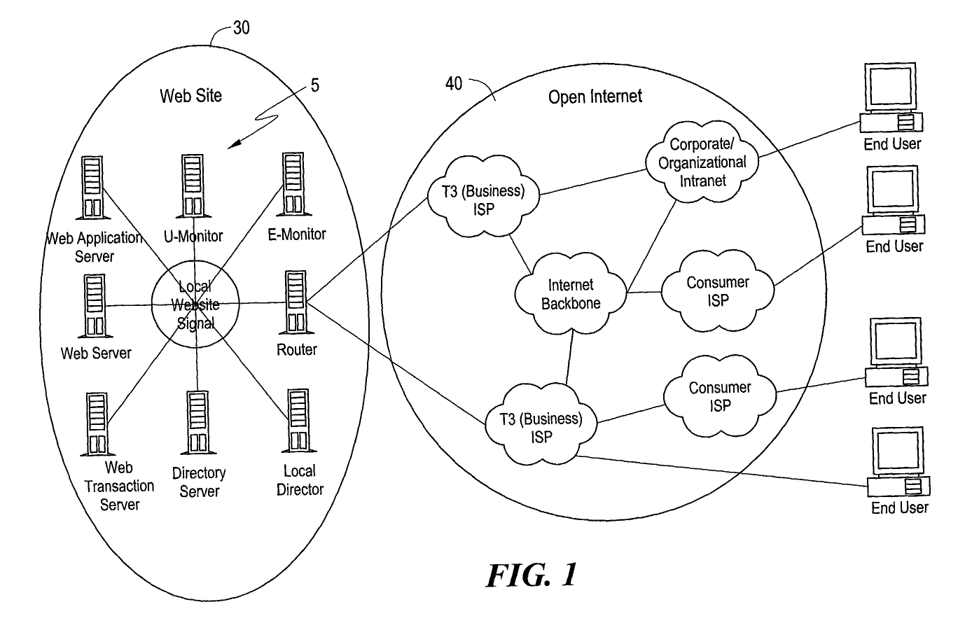

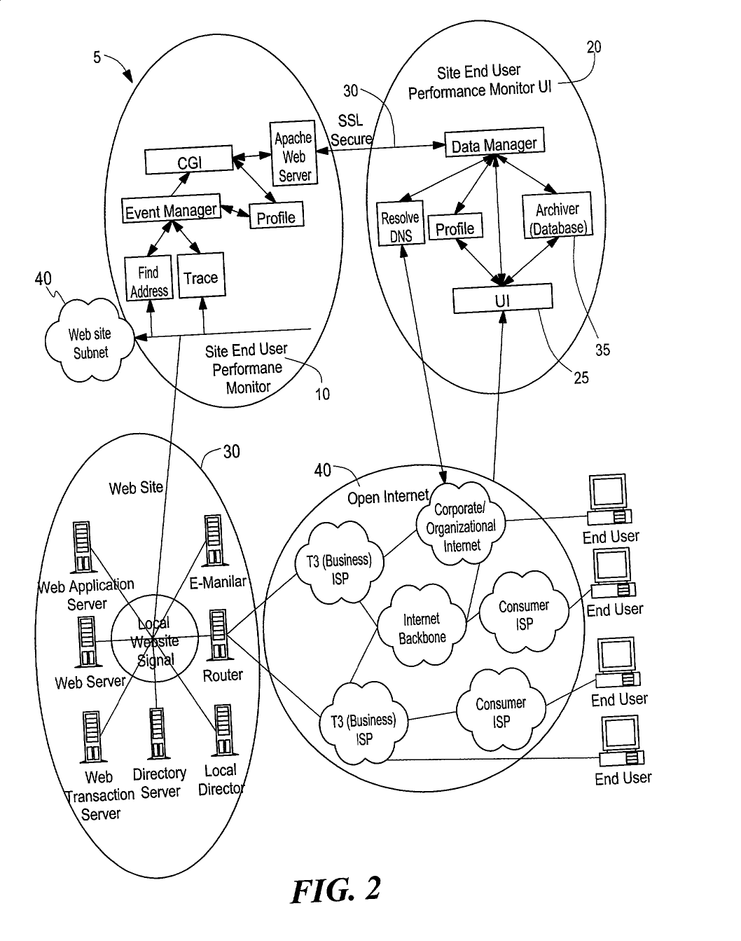

Referring generally to FIGS. 1 and 2, the back-tracing system 5 is comprised of a number of components, each making a distinct contribution to the overall operation of the product. These major components include: a web monitor 10, a client 20, and an interconnecting network protocol 40. The web monitor 10 includes a network packet capture function, a network trace function, and a web server. The web monitor 10 is located on its own server on the same subnet as the web server being monitored. The client 20 includes a user interface 25 that encapsulates both reporting and administrative functionality, a database 35 that stores data captured by the monitor 10, and network web client functionality. The user interface 25 is operated from a separate internet-connected machine on the premises of the back-tracing system user. The database 35 is preferably located on the same machine as the user interface 25. The interconnecting protocol 30 utilizes a combination of HTTP requests and XML data to enable capture of monitor data by the client 20 and control of the monitor 10 from the client 20.

FIG. 2 depicts the general architecture of the back-tracing system when the system is installed in its preferred configuration (with the monitor co-located on the same IP subnet that the sites web servers are located on).

The application resides on two machines. The monitor resides on a server that, preferably, is co-located on the same subnet that a sites web server resides on. The client resides on a desktop or server machine of the customers choosing, with the only requirement on placement being that the machine has web access, across the internet, to the web site that is being monitored. For web service providers that vend out the operation of their web servers, this provides an opportunity to maintain a local view of the operation of servers located in a remote caged environment. For web hosting companies, this provides means for locating a client in an operations center.

The system 5 may be used to monitor the network as a part of an overall web site monitoring system. The system 5 reports and saves data in a manner that will allow that data to be readily integrated with other data sources (log files, etc) in comprehensive web site reporting and analysis tools.

The network backtracing system 5 supports viewing of this volume data in a variety of ways, including contrasts against network performance measurements, post-mortem network performance analysis, reports and visualization. Data is maintained by the system for a user-specified period of time and can be retroactively queried and visualized in a variety of ways. An assortment of graphical display formats is supplied, including several ways of animating web site performance over time.

The system 5 performs as a QOS monitor at the web site 30 and actively monitors incoming traffic. When a new user is detected, the system 5 traces the route back to the user, measuring the performance of as many intermediate links as it can traverse. In some cases, this trace will extend back all the way to the end users machines. More often it will end at a corporate firewall or a router near the end users dial-up modem pool. Regardless of how close to the user the trace gets, however, the system 5 will track the performance of the actual routes that are being traversed by actual users at the time that those users are actually accessing the web site. The result, spread across measurements of many users, is a snapshot of the network quality of service that the web site 30 is actually experiencing, for the routes that are actually being used to access the web site 30.

The system features three “intervals”, a write interval, a trace interval, and a prune interval. The write interval is the “resolution” of the system. A user that requests fifteen web objects within a given write interval will generally be seen to have made fifteen requests, but only one of those requests will be processed as anything more than an increment to a counter. At each write interval, the monitor will write out a summary of what it has seen during that interval (e.g. the source users address and request volume, the network paths associated with those requests, and the individual links (router pairs) associated with those paths). A typical write interval may be set at one minute.

The monitor 10 will capture (“sniff”) all packets from the subnet 40 on which it is located. The “Find Address” or “sniffer” function captures the IP addresses of users that request data from the monitored web site. To do this, the backtracing system captures “syn” packets (a connection initiating request that is the beginning of any interaction with a web server) and finds the network address of the requesting user or user proxy and the network address of the destination server. If the user address is new within a write interval, it is processed as a new user address and passed on to the manager for additional consideration. If the user address has already occurred within an interval, a user request counter is incremented. The sniffer function typically will have a maximum rate of operation, above which some packets may be dropped. The monitor 10 will trace the network routes back to the captured source IP addresses. The monitor will further package information about the source IP's requests, the path from the source IP to the monitor, and the performance of the network on that path such that it can be transferred to the client. The monitor will also respond to requests from the client, which is presumed to be located at a customer's corporate site.

Each new IP address within a given write interval is time-stamped. The first time that a particular address is captured within a given trace interval, a traceroute is run on the address. Data from these tests is added to a temporary storage list. Addresses subsequently captured are compared to the addresses already in the list. To minimize processing and network traffic, the “trace functionality” considers individual user IP addresses within the context of the network from which it arrives. Two users operating from the same subnet will almost always use the same path to get to a given web site such that a trace to one user is effectively a trace to the other. Hence the need to trace back to a given user is not based on the user address, but is based on the subnet in which the user is hosted.

The trace interval is the frequency with which a given user's path will be traced back through the network. Network paths are generally enduring and fairly consistent such that a user path in one minute is extremely likely to be its network path 15 minutes, an hour, or a day later. Paths can change, however, and the path data should be updated every predetermined number of minutes. Again, this trace interval can be made configurable, such as an ordinal of the write interval, by the end user at some point.

The prune interval is the frequency with which the monitor drops old and unused data. A prune interval of several hours is typical.

Traceroutes originating from the backtracing system are distributed over some small set of hops for the first portion of their journey. Once this small set of hop combinations is discovered and stored, they need be refreshed only infrequently. Additionally, the Internet is partitioned into CIDR blocks, with large network service providers (NSPs), like MCI, allocated all the address space in an entire class A network, and large ISPs, like AOL, are allocated the address space in one or more class B networks. That being the case, the use of the back-tracing system to discover over time the addresses allocated to major CIDR blocks can be accomplished. When an IP address belonging to a previously discovered CIDR block is sniffed, a subnet mask applicable to the CIDR block is applied to the subsequent traceroute, and only the unknown portion of the route discovered.

Since the CIDR block “map” is maintained indefinitely in a database, the majority of required traceroutes will eventually need be only partial traces of the final portion of the path back towards a source. Computed traceroutes are written, once per interval, to a time-stamped file along with source and link information.

One method of maximizing the efficiency of the traceroute functionality is the establishment of a cascading grid of Router Domains that map the actual organization of the Internet. These Router Domains, and their cascade down into specific Router Blocks, CIDR blocks, routers, and discrete subnets, is not documented in any single place in the format in which the will be using it, and must be discovered by exploring the network referencing a variety of existing data sources, and applying heuristics that track the usual conventions by which network routers are named. The methodology used for this discovery is described below.

First, the public peering points (Routing Domains) as identified in ARIN (www.arin.net) are analyzed. At each peering point the inbound and outbound routes are extracted. The netnum and mask for each route are collected. The inbound routes will generally be more interesting than the outbound routes (as they represent request traffic). Each route found is followed, with each newly found router treated as another peering point, data collected as above and iterated.

All Tier 2 routes within routing domain are extrapolated, and broken out level by level to organizations. Routers are assigned to router blocks to routing domains based on the information listed below:

DNS Name (looking for city names (commonly used), airport codes (commonly used), zip codes, and area codes. Approximately sixty-five percent of the routers can be sorted based on this information.

Class C address (routers that are in the same class C domain are almost always in the same place).

DNS Location Information (e.g. GPS location). The system is able to identify about five percent of the routers using this information. This data will improve over time.

BOARDWATCH data (should resolve another 20% of routers).

Whois information (should resolve another 10% of routers).

It is expected that about 1% or routers worldwide will not be resolvable using this heuristic.

The results from the back tracing allow a web site owner to solve a variety of problems such as active identification of hot (high volume) and cold (poor performance/low speed) paths and nodes. The data obtained can be used for post hoc analysis. The results can also be used to identify problems in near real time, raising the possibility of starting to resolve QOS problems before users notice them. The data can further be used to actively identify users/companies/ISP's/etc with subpar performance. There is a subset of web sites, represented at least in part by lower volume, higher value sites like corporate business partner e-commerce sites, which will find immense value in their ability to proactively identify individual users or corporate sites that are having trouble reaching their site. The active measurement of site request volume provides, as an inevitable byproduct, a near real-time view of site traffic.

The client of the backtracing system collects data from the monitor on a periodic basis. The client stores that data in a local database and notifies the user interface of database updates. The client supports a variety of views of the data, including:

a running summary of observed network performance as viewed from the web site;

a “weather” report that shows, via several views and drill downs, the distribution of volume;

performance across the network which includes a geographic network view and several list views as well as a logical topological view;

a network “latency” report that highlights, via several views, network performance over time and performance bottlenecks in the network which may include a tabular view, a graphical view of network latency over time, and a graphical view of latency “hot spots”;

a network “volume” report that highlights, via several views, network volume over time and volume hotspots in the network which may include a tabular view, a graphical view of network volume over time, and a graphical view of volume “hot spots”;

a “user” report that highlights individual users that are experiencing subpar performance, and which, through a series of drill downs, enables diagnosis of where their network bottlenecks may be;

a “database” query view that allows various reports to be generated from the captured data; and

a “profile” view that enables management of the profile that controls automated operation of the monitor, the database, and the UI.

The client will communicate profile changes back to the monitor.

The client is comprised of a User Interface, an SQL Database, Communications and Database Management, and a DNS Lookup Functionality.

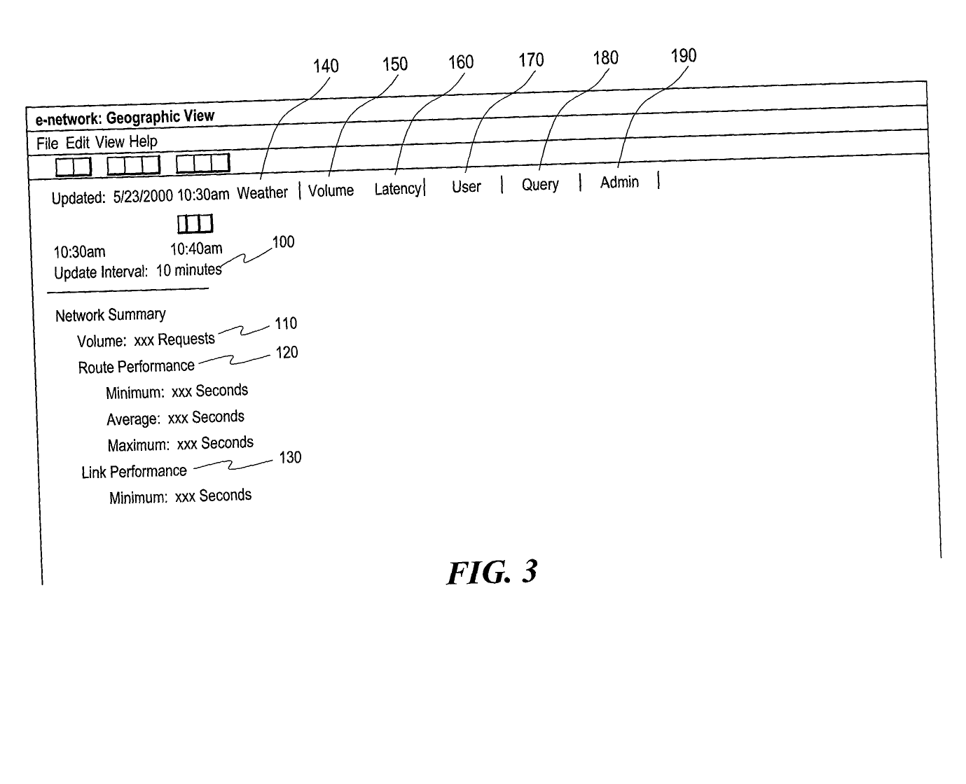

The User Interface of the backtracing system is comprised of a summary panel and a set of selectable tabbed panels. There are six selectable tab contexts, several of which will support several views and/or drill downs. The six selectable tab contexts are shown in FIG. 3:

Weather 140: A generalized view of the network surrounding the monitored site that supports drill down, through several levels of list, to specific problem routers/links.

Volume 150: A view of the request volume associated with the monitored site, including both a view of volume variations across time (24 hours) and of principle volume sources at a given point in time.

Latency 160: A view of the network latencies associated with routers feeding the monitored site, including both a view of router latency variations across time (24 hours) and of problematic locations on the network at a given point in time.

User 170: A view of user performance at a particular point of time that supports drill down to a users performance profile over time (span of database) and the specific paths and router/link latencies that a specific user experienced at a particular point in time.

Query 180: Database report generation and query functionality.

Admin 190: Functionality to “start” and “stop” the monitor remotely. Functionality that maintains the profile that manages function across the monitor and client.

The backtracing database closely reflects the structure of the backtracing results reporting XML format that is used in the system and includes specific enhancements that are intended to improve system performance. Typically, the backtracing database includes the following tables, fields, and keys:

| Table | Fields | Key Fields |
|---|---|---|
| Source | IP, Time, Volume, PathID, | IP, Time, PathID, |
| | HopCount, DestMask | DestMask |
| Node | PathID, HOPID, Hop #, RTT, | PathID, HopID, |
| | Time, DestMask | Time, DestMask |
| Link | HopIP, NextHopIP, RTT Diff, | HopID, NextHopID, |
| | Pair Volume, Time, DestMask | Time, DestMask |
| DNS | IP, Name, Routing Domain Mask | IP, Routing Domain |
| | | Mask |
| Routing | Mask, Location, IP Range, N of | Mask |
| Domain | Subdomains, Parent Domain, | |
| | Volume, Min/Ave/Max Latency, | |
| | Type, Tier | |
| Aggregated | Time, Volume, Min/Ave/Max | Time |
| Data | Latency, Min/Ave/Max RTT, | |
| | Slowest Routing Domain, Highest | |
| | Volume Routing Domain, Slowest | |
| | User, Highest Volume User | |

The backtracing system can also provide geographic data on the captured packets. As mentioned above, the capture and test component also performs a DNS lookup on any “new” captured addresses. If LOC data is not available for a particular IP address, comparisons are made with existing paths in the database. Finding the hops common to the address in question and the closest matching path in the database glean some general geographic data.

As mentioned earlier, each set of captured IP addresses is time-stamped and compared to addresses held in a temporary storage list. If the address is already in the list and the difference between the current time-stamp and the former time-stamp is less than 10 minutes, a volume counter is incremented, but a new traceroute is not run. If the address is in the list, but the difference in time-stamps is greater than 10 minutes, a new traceroute will be run. This will allow changes in the network to be captured. Addresses showing no additional activity over a period of thirty minutes are pruned from the list.

The summary view and six selectable tabbed contexts are described below. It should be noted that the display, in all of these contexts, is updated on a user configurable frequency. The current default is presumed to be ten minutes, but the tool will support other frequencies.

The Summary View, visible in the left hand panel of FIG. 3, provides a variety of summary statistics concerning the state of the network, as seen from the web site, in the currently displayed interval. Information displayed in this panel is described below.

The data relating to different time measurements 100 is shown. The end of interval time for the currently displayed data. The time remaining to the next update and the length of the update interval. Double clicking on the network interval exposes the Admin panel.

The total site network request volume for that interval. Double clicking on request volume exposes the volume panel's request volume over time view.

Route and Link Performance for routes entering the site within an interval, expressed as minimum, average, and maximum. Double clicking on Link Average exposes the latency panel's latency over time view. Double clicking on minimum or maximum link exposes the latency panel's list views “drill down to list of pairs” view. Double clicking on Route Average exposes the user view context.

Double clicking on Route min or max exposes the lowest level user drill down (e.g. the path and latency view for a specific user at a specific time) for the specific route selected. Hottest spot data, including identifications of the slowest route, slowest link, slowest user performance, and highest user volume is displayed. Double clicking on Slowest Route or Slowest User Performance should expose the lowest level user drill down (e.g. the path and latency view for a specific user at a specific time) for the specific route selected. Double clicking on slowest link exposes the latency panel's list views “drill down to list of pairs” view. Double clicking on highest volume exposes the volume panel's request highest volumes graph view.

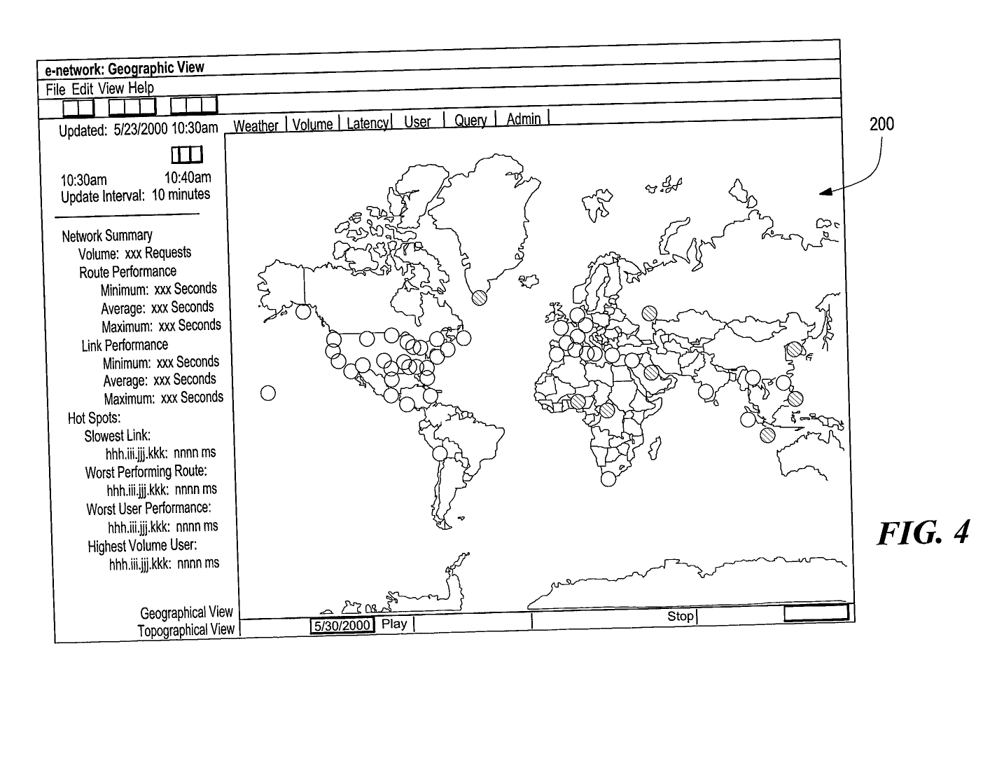

Referring now to FIG. 4, a “weather” view is shown. The weather context provides a compact view of the health of the network. It features three views and a detailed drill down that combine volume and network performance data in a single visual. The initial views available in the weather context are a geographical view, a “network over time” view, a list view, and a topographical view. The geographical view 200 shown in FIG. 4 superimposes dots, each representing a routing domain, over a map of the world, with network performance depicted as color and network volume as dot size. The “network over time” view presents 24 hours of volume and latency information in a line graph. The list view shows all routing domains, sorted in the order of their network performance (slowest at the top, fastest at the bottom), with entries color coded in the same way that the dots are. The topographical view shows the logical relationship of routing domains, regardless of their geographical location.

In the geographic view of the network weather the size of dots are log scaled (e.g. 10 or less, 100 or less, 1000 or less, 10,000 or less, 100,000 or less, 1 million or less, etc.). Dot colors can be any color, and in the described embodiment are green, yellow, and red. Green indicates that a router domain is experiencing acceptable performance throughout. Yellow indicates that one or more router blocks within a router domain are experiencing borderline performance on one or more routers. Red indicates that one or more router blocks within a router domain are experiencing unacceptable performance on one or more routers. The definitions of acceptable, borderline, and unacceptable represent some deviation above the time of day norm. Borderline performance corresponds to performance slower than the first or second standard deviation of performance for routers at a given time of day. Unacceptable performance corresponds to performance slower than approximately the third or fourth standard deviation of performance for routers at a given time of day.

The Geographic view supports animation through an animation interface. Components of this interface include PLAY, PAUSE, STOP, and REWIND buttons. Additional components include an animation slider and configuration for the period and speed of the animation.

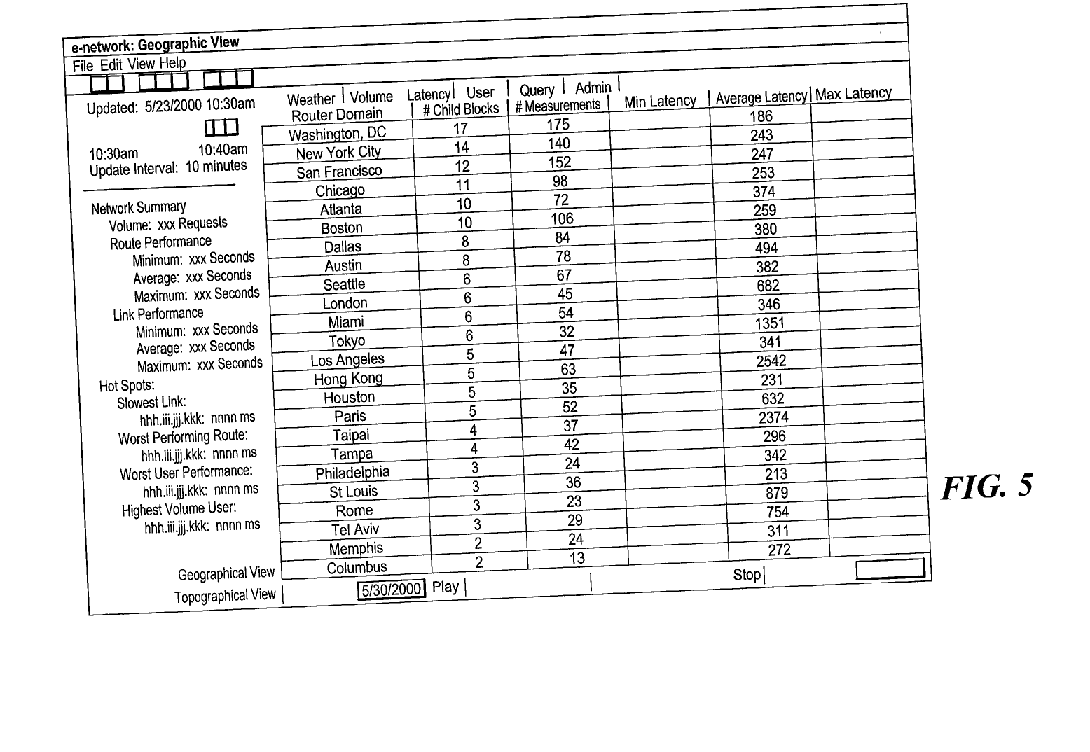

FIG. 5 shows the table view of the weather context. The weather context supports a series of drill downs as follows:

Geographic View of Router Domains with color coded performance and log sized volume are displayed; Topographical view of Router Domains with color coded performance and log sized volume; Performance Table of Router Domains (sorted from cold or slowest performance to hot or fastest performance) with Hot Volume Data (Router Domain Name, n or Router Blocks, n of performance measurements, min/ave/max latency, volume).Table of Router Blocks within Router Domains with performance and volume information (Ownership, Block Name, Block Address, n or Routers in Block, n of performance measurements, min/ave/max latency, volume); table of routers within Router Block (Ownership, DNS name, address, n of Feeding Routers, n of performance measurements, min/ave/max latency, volume); and Table of Feeding Routers for Selected Router (Ownership, DNS name, address, min/ave/max latency, volume).

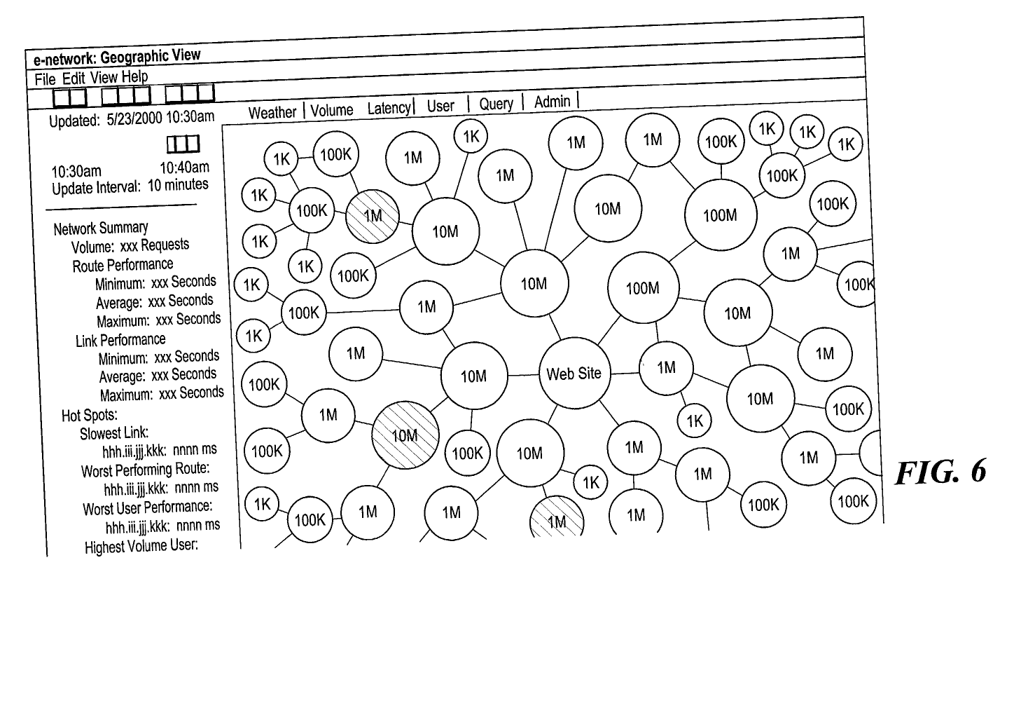

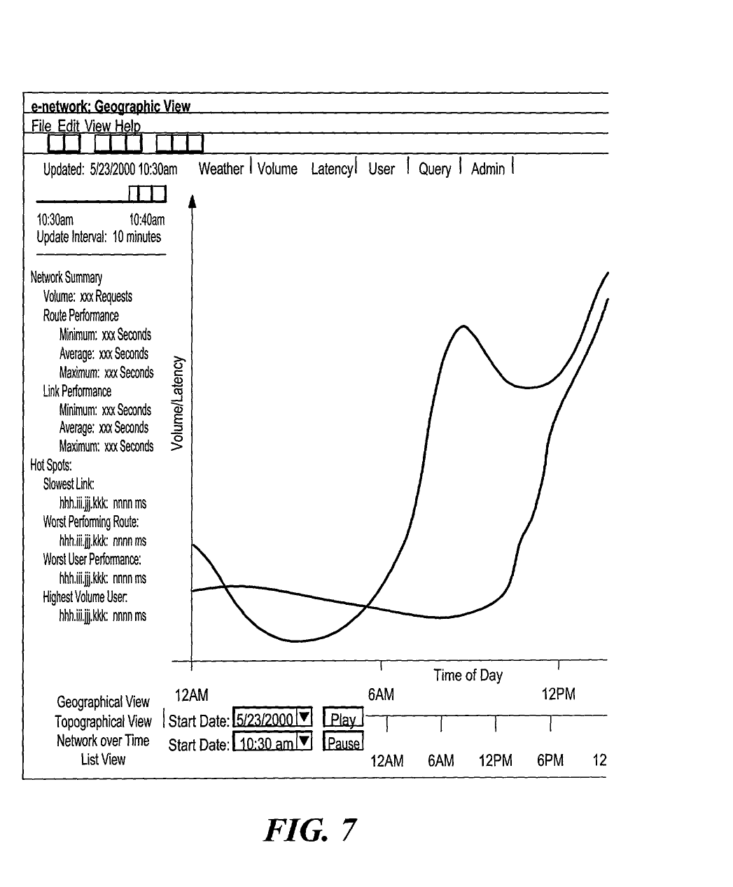

The Topological View of the Weather Context is shown in FIG. 6. The network over time view of the Weather context reports on both the volume and latency over the prior twenty-four hours, allowing a comparative view. The resulting network over time is shown in FIG. 7.

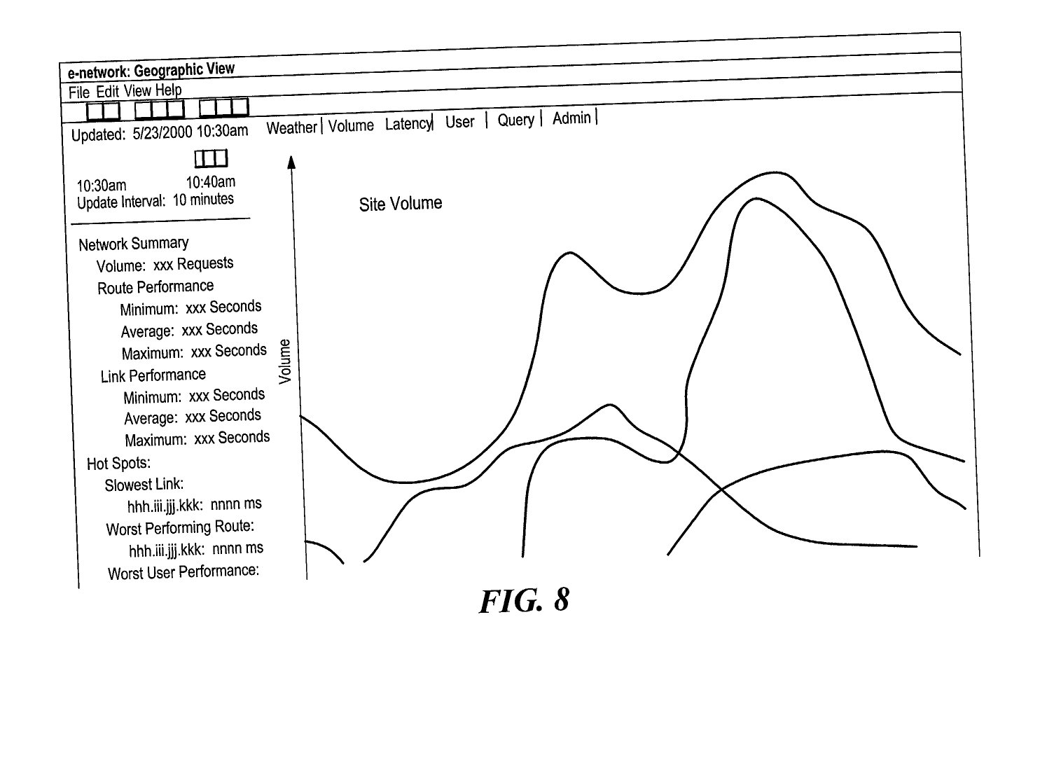

The volume context provides several views of web site volume, including a volume over time view, a volume distribution view, and a volume list view. The web site volume over time view, shown in FIG. 8, provides for display of overall volume, optional display of a baseline (the average of the previous 7 days), and various subsets of content (based on Geography, Router Domain, and/or ISP):

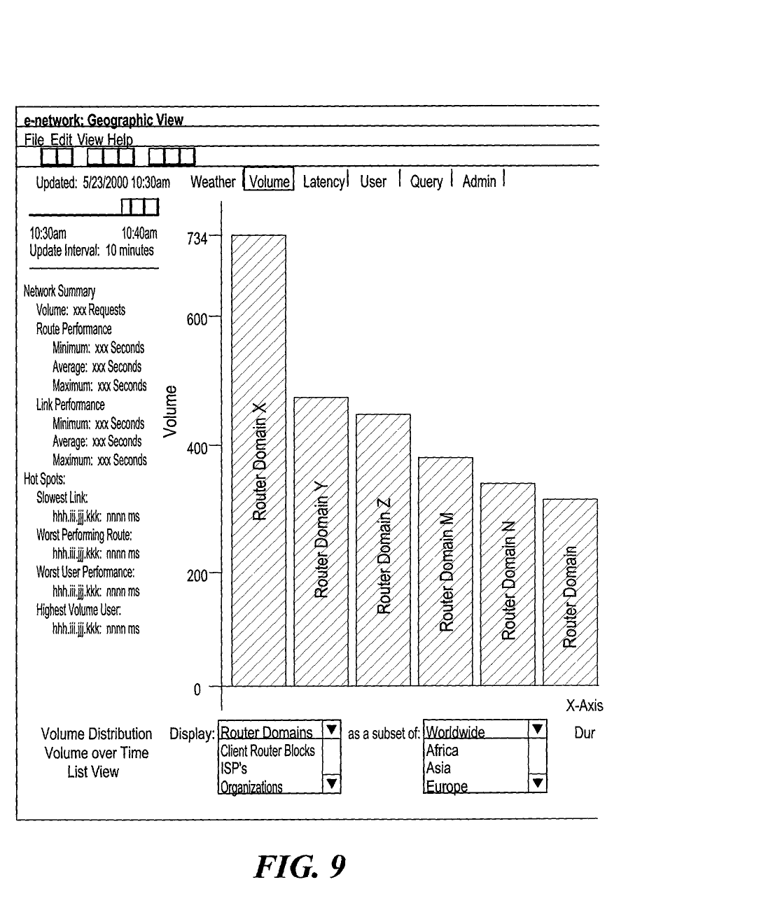

The Volume Distribution view, shown in FIG. 9, provides various ways of viewing high volume network route points, both on a worldwide basis and within geography. Options are provided to display an average volume across all router domains, to change the duration across which data is accumulated for display, to select the beginning of the display interval, and to animate volume distribution over a period of time.

A list view (not shown), sorted by volume, is also provided. The data display can be constrained in the same manner as the volume distribution view, and is a different view of the same data. No drill downs are provided from the volume context.

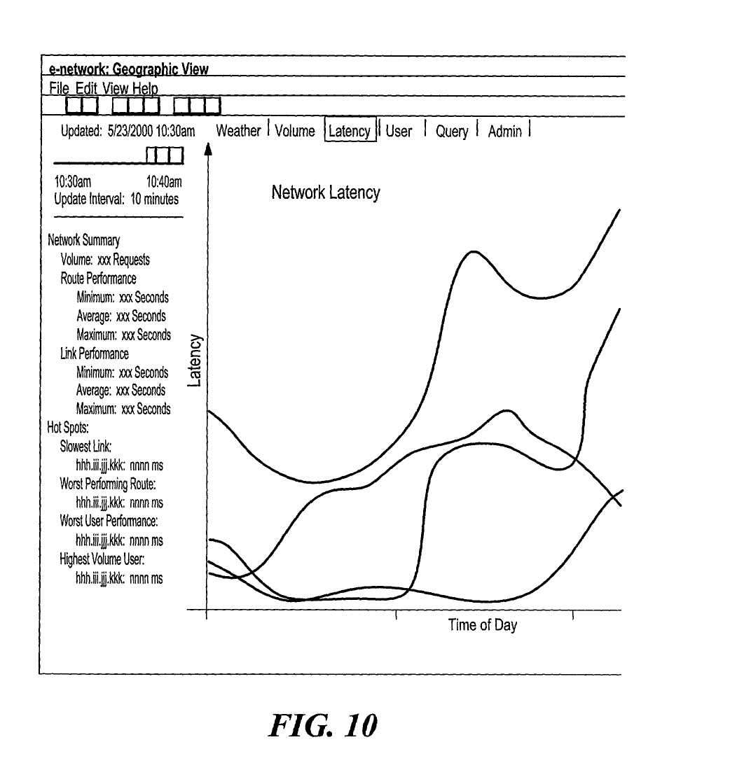

The latency context provides several views of network latency as viewed from a web site, including a network latency over time view, a latency distribution view, and a latency list view. The network latency over time view, shown in FIG. 10, provides for display of average latency during a given time interval, optional display of a baseline (e.g. the average of the previous 7 days), and various network subsets (based on Geography, Router Domain, and/or ISP).

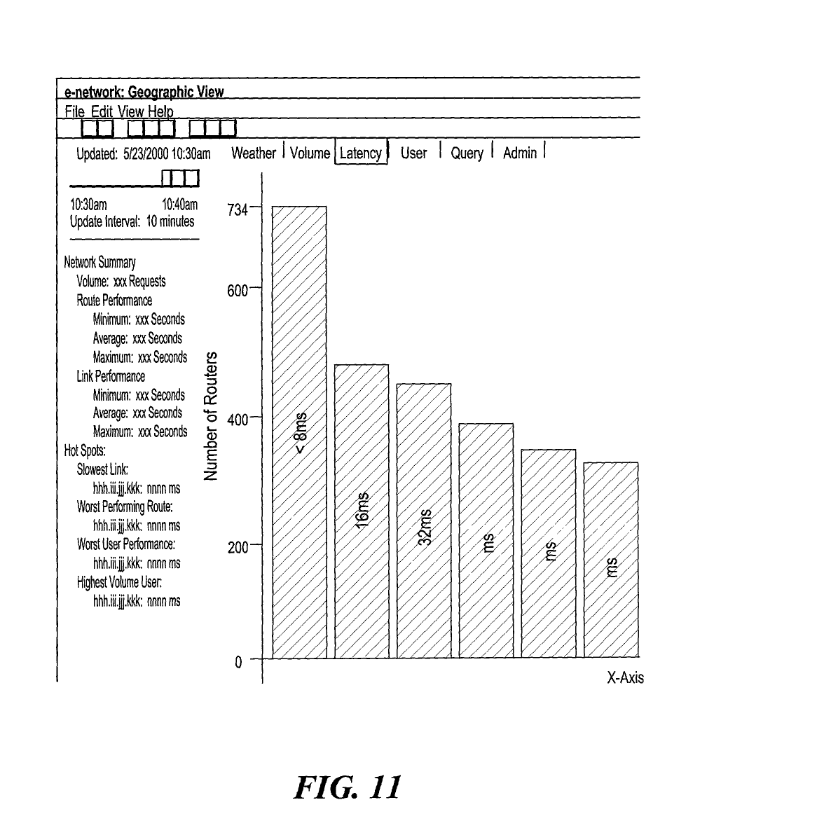

The Latency Distribution view, shown in FIG. 11, provides a view of the latency of all of the routers that are visible from the monitored web site or other location, both on a worldwide basis and within geography. Options are provided to display the latency distribution across all router domains, to change the duration across which data is accumulated for display, and to select the beginning of the display interval.

The latency distribution view supports drill down from the vertical bars of the histogram to a list of the routers represented by that vertical bar (sorted by latency). This drill down is formatted in the same manner as the “Table of Routers Within Router Block” view (e.g. Ownership, DNS name, address, n of Feeding Routers, n of performance measurements, min/ave/max latency, volume), but groups routers based on their current performance. The list view associated with the latency context is the first drill down of the weather view, the “Table of Router Blocks”.

The User Context contains a list of source IP addresses (e.g. users, or at least the machines they use), sorted by their performance, and provides two levels of drilldown. The list of users (or source IP's) will display, for each source IP, the network name of the source IP, the source IP address, the number of accesses associated with that source IP in the current (or selected) interval, the number of measurements we have for that source IP in the interval (typically, but not necessarily, one), and the (average) latency associated with that source IP. There can be a large number of source IP's in any given interval. To ensure good performance, users will be displayed in blocks of 100. An address search capability will allow rapid traversal to results for a specific address or network name.

The first drill down from the user context table will show all of the accesses that are currently listed in the database, in the reverse order of their arrival (most recent access listed first). Again, to ensure good performance, accesses will be displayed in blocks of 100. User, time, and date search specifications within this view will allow rapid traversal to a specific point in time or a quick change to viewing the results associated with another user. The third drill down will display the path and link latency information associated with a specific users accesses at a specific point in time.

The query context is intended to provide for generalized query and reporting from the backtracing database.

The Admin context allows generalized control of parameters that affect the automated operation of the monitor and client. Components of the Admin Context include:

Server Start and Stop Buttons

Profile Update Button

Ignore srcIP list (list of srcIP's that should be ignored; e.g. the client, admin machines, automated monitors like Keynote, etc)

Local subnet filter (local subnet address which, used as mask on both source and destination, can exclude local traffic on the subnet)

DNS (address of local DNS server)

Latency Intervals

Aggregation (frequency of data write by monitor: currently 1 minute)

Display (frequency of data update in UI: currently 10 minutes; must be ordinal of aggregation interval)

Data Pull (frequency of data pulls from monitor: currently Aggregation Interval/2)

Trace Route Refresh (frequency of refresh for path and latency information; currently 10 minutes)

Server Pruning (frequency of deletion of unused nodes)

DB Pruning (frequency with which old data is removed from dB)

The backtracing system API enables the following functionality: collection of formatted XML data from the monitor; updating of monitor profile data from the client, and administrative control of the monitor from the client, including monitor start and stop.

Support for this functionality is supported through two discrete API's. The first is an XML data packaging format that describes the data collected on the monitor in a manner that is human readable but which can be readily automated into both direct user interface displays and data storage. The second is an HTTP CGI format that enables the passing of commands and data from the client to the monitor.

The web monitor is capable of capturing data at a rate of at least 1000 hits/second on the monitored web site. Sniffed IP addresses are time-stamped. A comparison of newly captured addresses and stored addresses is used to perform “smart testing.” The capture & test function is capable of communicating with the database and the UI. Data in the temporary list is used to update the database and the UI on a configurable cycle, with the current presumed default being ten minutes. No data is lost, regardless of loss of client connection, unless server storage space becomes an issue, in which case data is dropped on a first in, first out basis. Traffic data from the last ten minutes should be stored and continuously refreshed.

The User Interface/Database Client includes the following features. All new addresses will have a traceroute and DNS lookup performed on them. New path and location data is stored in a temporary list. All data from the capture and test component is written to an MS SQL database. This information is used to preserve the source, link, and path content. Traffic data is maintained in the database for a configurable period of time, with the configuration default set to three months. Data is refreshed on a continuous basis with data greater than the configured period deleted from the database. The database permits the customer to backup old data before the old data is deleted.

Customers who will be interested in buying this product include: High Volume Web Sites, who will want to be able to readily identify any network impediments to growth; High Value Web Sites, who will want to be able to identify customers who are having web site performance problems; Corporate Intranet Web Sites, for which Quality of Service is frequently a key measurement of success; and Web Site Service Resellers, who frequently must make quality of service commitments to get and keep business.

Users who will use this data will include: Web Site Planning and Performance Monitoring Staff, Level 2 Help Desk, Network Monitoring Staff, and Network Performance Resolution SWAT teams.

As described above, the present invention locates a Quality of Service (QOS) monitor at a web site that actively monitors incoming traffic. When the monitor detects a new user, the monitor traces the route back to the user, measuring the performance of as many intermediate links as the monitor can traverse. In some cases, this trace will extend back all the way to the end users machines. More often the trace will end at a corporate firewall or a router near the end users dial-up modem pool. Regardless of how close to the user the trace gets, it will track the performance of the actual routes that are being traversed by actual users at the time that those users are actually accessing the web site. The result, spread across measurements of many users, is a snapshot of the network quality of service that the site is actually experiencing, for the routes that are actually being used to access the site. Accordingly, a more realistic and accurate result is obtained.

Having described preferred embodiments of the invention it will now become apparent to those of ordinary skill in the art that other embodiments incorporating these concepts may be used. Additionally, the software included as part of the invention may be embodied in a computer program product that includes a computer useable medium. For example, such a computer usable medium can include a readable memory device, such as a hard drive device, a CD-ROM, a DVD-ROM, or a computer diskette, having computer readable program code segments stored thereon. The computer readable medium can also include a communications link, either optical, wired, or wireless, having program code segments carried thereon as digital or analog signals. Accordingly, it is submitted that that the invention should not be limited to the described embodiments but rather should be limited only by the spirit and scope of the appended claims.

What is claimed is:

1. A computer program product for backtracing network performance, the computer program product comprising a computer usable medium having computer readable code thereon, including program code comprising:
instructions for causing a processor to perform as a web monitor, said web monitor capturing a source address of a packet received from a network, said web monitor performing a network backtrace on said source address; and
instructions for causing a processor to perform as a client, said client collecting and processing data resulting from said network backtrace, said client presenting results of said processing.

2. The computer program product of claim 1 further comprising instructions for causing a processor to access a database, said database storing data captured by said web monitor

3. The computer program product of claim 1 further comprising instructions for causing said client to perform a reporting function.

4. The computer program product of claim 1 further comprising instructions for causing said client to perform an administrative function.

5. The computer program product of claim 1 wherein said backtrace extends to a system selected from the group consisting of an end-user machine, a firewall and a router.

6. The computer program product of claim 1 further comprising instructions for causing a processor to capture a plurality of packets, for identifying SYN packets within said plurality of packets, for extracting source addresses from said SYN packets, and for extracting destination addresses from said SYN packets.

7. The computer program product of claim 6 further comprising instructions for causing said monitor to trace the network routes back to said captured source address.

8. The computer program product of claim 6 further comprising instructions for causing said monitor to observe the performance of the network on the path from said source address to said client.

9. The computer program product of claim 1 further comprising instructions for causing said product for backtracing network performance to include a plurality of intervals.

10. The computer program product of claim 9 wherein one of said intervals comprises a write interval.

11. The computer program product of claim 9 wherein one of said intervals comprises a trace interval.

12. The computer program product of claim 9 wherein one of said intervals comprises a prune interval.

13. The computer program product of claim 10 wherein when a user address is new within a write interval said user address is processed as a new user address, and when a user address has already occurred within a write interval a user request counter is incremented.

14. The computer program product of claim 10 wherein each new address within a write interval is time-stamped.

15. The computer program product of claim 11 wherein the first time a particular address is captured within a trace interval a traceroute operation is run on said address.

16. A method of backtracing network performance comprising the steps of:
capturing a source address of a packet received from a network;
performing a network backtrace on said source address;
collecting and processing data resulting from said network backtrace; and
presenting results of said collecting and processing.

17. The method of claim 16 further comprising the step of accessing a database, said database storing data captured by said backtrace.

18. The method of claim 16 further comprising the step of performing a reporting function.

19. The method of claim 16 further comprising performing an administrative function.

20. The method of claim 16 wherein said backtrace extends to a system selected from the group consisting of an end-user machine, a firewall and a router.

21. The method of claim 16 further comprising the steps of:
capturing a plurality of packets;
identifying SYN packets within said plurality of packets;
extracting source addresses from said SYN packets; and
extracting destination addresses from said SYN packets.

22. The method of claim 21 further comprising the step of tracing the network routes back to said captured source address.

23. The method of claim 21 further comprising the step of observing the performance of the network on the path from said source address to said client.

24. The method of claim 16 wherein when a user address is new within a write interval said user address is processed as a new user address, and when a user address has already occurred within a write interval a user request counter is incremented.

25. The method of claim 10 wherein each new address within a write interval is time-stamped.

26. The method of claim 16 wherein the first time a particular address is captured within a trace interval a traceroute operation is run on said address.
